(19) United States
(12) Patent Application Publication
(10) Pub. No.: US 2015/0017350 A1
(43) Pub. Date: Jan. 15, 2015

(54) Display Kit for Gourds, Vegetables, and Other Objects

(71) Applicant: Plaid Enterprises, Inc., Norcross, GA (US)

(72) Inventor: Greg Myracle, Orange, VA (US)

(73) Assignee: Plaid Enterprises, Inc., Norcross, GA (US)

(21) Appl. No.: 13/937,812

(22) Filed: Jul. 9, 2013

(51) Int. Cl. B44C 5/06

(52) U.S. Cl. CPC B44C 5/06
USPC 428/7; 428/99; 428/22; 428/16

(57) ABSTRACT

A press ornament (100) includes an ornamental article (101), a first insertion shaft (102), and a second insertion shaft (103). The first insertion shaft extends distally from the ornamental article in a first direction and the second insertion shaft extends distally from the ornamental article in a second direction. The first insertion shaft and the second insertion shaft to insert into one or more objects, such as a vegetable, gourd, or synthetic object, to attach the press ornament thereto to form a display.

### BACKGROUND

1. Technical Field

This disclosure relates generally to items for creating displays, and more particularly to items for creating displays in vegetables, gourds, and other objects.

2. Background Art

Carving pumpkins to create “Jack O' Lanterns” is a tradition that has continued for centuries. The common understanding is that pumpkin carving has its origins in an Irish myth about a person called “Stingy Jack.” As the legend goes, after inviting the devil for a drink, Stingy Jack did not want to pay for the consumed alcohol. The devil turned himself into a coin to pay for the drinks. Having done so, Jack still did not want to pay and put the coin in his pocket next to a silver cross that kept the devil in coin form. Jack eventually freed the devil, only to capture him again, and later free him again under the promise that Jack would not be bothered by the devil for at least ten years. Further, the devil agreed not to take Jack's soul when he died.

Upon Jack's death, he was not admitted into heaven. The devil, upset by the deal struck with Jack, refused to take him as well. Jack thus set out wandering the earth with only a piece of coal to light his way. He put the coal into a carved turnip. The Irish referred to the wandering figure as “Jack of the Lantern,” or colloquially as “Jack O'Lantern.”

People then began to make their own Jack O'Lanterns by carving scary faces into turnips, potatoes, beets, pumpkins, or other vegetables, and placing them in windows and doors to frighten away Stingy Jack. People today continue this tradition by primarily carving pumpkins to create Jack O'Lanterns. The tradition has evolved with people creating more and more intricate features and designs in pumpkins.

The process of carving a pumpkin can be challenging for those lacking artistic skills. While nearly anyone can carve a simple face, more complex designs often require specialized artistic skills. To help those “artistically challenged” Halloween revelers create more interesting pumpkin displays and Jack O'Lanterns, manufacturers have introduced “pumpkin carving kits” that include templates, cutting tools, and other implements for creating a pumpkin display.

These prior art pumpkin carving kits have drawbacks, however. Prior art pumpkin carving kits are traditionally messy and cumbersome to use. One of the biggest problems with prior art pumpkin carving kits is that they include sharp knives, saws, and other cutting instruments. Consequently, young children generally are not able to use them due to the fact that they are dangerous.

Illustrating by example, most prior art pumpkin carving kits, tools, or products include one or more saws, knives, or other sharp blades. A user is instructed to cut designs into the pumpkins using these saws, knives, and blades. The designs may be in accordance with a template included with the kit. Alternatively, they may be freehand. These sharp tools are dangerous. They are especially dangerous for younger users. Moreover, these prior art kits require a lot of time for proper designs to be created and result in a large mess when various parts and pieces are cut from the pumpkin.

A second problem lies in the fact that many prior art pumpkin carving kits are sold as “single-use” items and can accordingly only be used one time. Disposing of sharp knives, blades, saws, and other items can be a challenge, as one does not want anyone handling a garbage receptacle containing these devices to cut themselves.

It would be advantageous to have an improved display kit.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates a perspective view of one explanatory press ornament in accordance with one or more embodiments of the disclosure.

FIG. 2 illustrates a front elevation view of one explanatory press ornament in accordance with one or more embodiments.

FIG. 3 illustrates a right elevation view of one explanatory press ornament in accordance with one or more embodiments.

FIG. 4 illustrates a left elevation view of one explanatory press ornament in accordance with one or more embodiments.

FIG. 5 illustrates a top plan view of one explanatory press ornament in accordance with one or more embodiments.

FIG. 6 illustrates a bottom plan view of one explanatory press ornament in accordance with one or more embodiments.

FIG. 7 illustrates a front elevation view of another explanatory press ornament in accordance with one or more embodiments.

FIG. 8 illustrates a right elevation view of another explanatory press ornament in accordance with one or more embodiments.

FIG. 9 illustrates a left elevation view of another explanatory press ornament in accordance with one or more embodiments.

FIG. 10 illustrates a top plan view of another explanatory press ornament in accordance with one or more embodiments.

FIG. 11 illustrates a bottom plan view of another explanatory press ornament in accordance with one or more embodiments.

FIG. 12 illustrates a front elevation view of another explanatory press ornament in accordance with one or more embodiments.

FIG. 13 illustrates a right elevation view of another explanatory press ornament in accordance with one or more embodiments.

FIG. 14 illustrates a left elevation view of another explanatory press ornament in accordance with one or more embodiments.

FIG. 15 illustrates a top plan view of another explanatory press ornament in accordance with one or more embodiments.

FIG. 16 illustrates a bottom plan view of another explanatory press ornament in accordance with one or more embodiments.

FIG. 17 illustrates a front elevation view of another explanatory press ornament in accordance with one or more embodiments.

FIG. 18 illustrates a right elevation view of another explanatory press ornament in accordance with one or more embodiments.

FIG. 19 illustrates a left elevation view of another explanatory press ornament in accordance with one or more embodiments.

FIG. 20 illustrates a top plan view of another explanatory press ornament in accordance with one or more embodiments.

FIG. 21 illustrates a bottom plan view of another explanatory press ornament in accordance with one or more embodiments.

FIG. 22 illustrates a front elevation view of another explanatory press ornament in accordance with one or more embodiments.

FIG. 23 illustrates a right elevation view of another explanatory press ornament in accordance with one or more embodiments.

FIG. 24 illustrates a left elevation view of another explanatory press ornament in accordance with one or more embodiments.

FIG. 25 illustrates a top plan view of another explanatory press ornament in accordance with one or more embodiments.

FIG. 26 illustrates a bottom plan view of another explanatory press ornament in accordance with one or more embodiments.

FIG. 27 illustrates a front elevation view of another explanatory press ornament in accordance with one or more embodiments.

FIG. 28 illustrates a right elevation view of another explanatory press ornament in accordance with one or more embodiments.

FIG. 29 illustrates a left elevation view of another explanatory press ornament in accordance with one or more embodiments.

FIG. 30 illustrates a top plan view of another explanatory press ornament in accordance with one or more embodiments.

FIG. 31 illustrates a bottom plan view of another explanatory press ornament in accordance with one or more embodiments.

FIG. 32 illustrates a front elevation view of another explanatory press ornament in accordance with one or more embodiments.

FIG. 33 illustrates a right elevation view of another explanatory press ornament in accordance with one or more embodiments.

FIG. 34 illustrates a left elevation view of another explanatory press ornament in accordance with one or more embodiments.

FIG. 35 illustrates a top plan view of another explanatory press ornament in accordance with one or more embodiments.

FIG. 36 illustrates a bottom plan view of another explanatory press ornament in accordance with one or more embodiments.

FIG. 37 illustrates part of an explanatory method of creating a pumpkin display in accordance with one or more embodiments.

FIG. 38 illustrates another part of an explanatory method of creating a pumpkin display in accordance with one or more embodiments.

FIG. 39 illustrates another part of an explanatory method of creating a pumpkin display in accordance with one or more embodiments.

FIG. 40 illustrates another part of an explanatory method of creating a pumpkin display in accordance with one or more embodiments.

FIG. 41 illustrates an explanatory pumpkin display in accordance with one or more embodiments.

FIG. 42 illustrates another explanatory press ornament configured in accordance with embodiments of the disclosure.

FIG. 43 illustrates another explanatory press ornament and method of decorating the same, both in accordance with one or more embodiments of the disclosure.

FIG. 44 illustrates another explanatory press ornament and method of decorating the same, both in accordance with one or more embodiments of the disclosure.

FIG. 45 illustrates another explanatory press ornament configured in accordance with one or more embodiments of the disclosure.

FIG. 46 illustrates another explanatory press ornament and method of decorating the same, both in accordance with one or more embodiments of the disclosure.

FIG. 47 illustrates another explanatory press ornament in accordance with one or more embodiments of the disclosure.

FIG. 48 illustrates another explanatory press ornament in accordance with one or more embodiments of the disclosure.

FIG. 49 illustrates another explanatory press ornament and method of using the same, both in accordance with one or more embodiments of the disclosure.

FIG. 50 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to creating displays with vegetables, such as turnips, pumpkins, watermelons, gourds, and other like objects, using press ornaments as described below. Alternate implementations are included, and it will be clear that various steps may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide a quick and simple decorating item that can be used with vegetables, gourds, Styrofoam articles, or other similar soft, penetrable articles to create a unique and aesthetically pleasing display article. In one embodiment, a press ornament comprises an ornamental article disposed between two insertion shafts. The ornamental article can be configured as a character, a geometric object, a natural object, a toy, sporting memorabilia, logos, advertisements, fashion designs, sticker backings, photograph backings, words, silhouettes, and so forth.

Using pumpkin decorating as an illustrative example, in one embodiment, the ornamental article can be configured as a bat, pumpkin, witch, ghost, or cat. By cutting a pumpkin into two lobes, one may create a pumpkin display by inserting the first insertion shaft into an edge of one lobe. The second insertion shaft can then be inserted into an edge of the second lobe. By spacing a plurality of press ornaments about the edges of the lobes, the two lobes will be suspended apart with the ornamental object visible between the lobes. Placing a light source, such as a candle, light emitting diode, or incandescent light within the object allows light to selectively shine around the ornamental articles to create a silhouetted, glowing display article.

For ease of discussion, explanatory embodiments described below will be suitable for creating a pumpkin design, such as one suitable for use as a Halloween decoration. However, it will be obvious to those of ordinary skill in the art having the benefit of this disclosure that embodiments of the disclosure are not so limited. For example, in another application, embodiments of press ornaments can be used to create a seasonal display. In such an application, the ornamental article may be configured as a leaf, pinecone, acorn, squirrel, bird, or other object. In another application, embodiments of press ornaments may be used to create a sporting enthusiast's display. In such an application, the ornamental objects may be configured as sporting logos, hats or helmets, bats, balls or clubs, or other sporting paraphernalia. Other applications—and correspondingly other configurations of ornamental objects—will be obvious to those of ordinary skill in the art having the benefit of this disclosure. For example, as will be shown below, in one embodiment the ornamental object could be configured as a flat surface suitable for placing stickers, paint, ink, advertising, designs, pictures, fashion designs, and so forth.

When used to decorate pumpkins, embodiments of the disclosure provide solutions to the problems mentioned above associated with prior art pumpkin decorating kits. Recall from above the fact that prior art pumpkin carving kits are messy, single use, and dangerous for small children. Embodiments of the disclosure provide simple press ornaments that are suitable for pressing into soft objects such as pumpkins. They can be used again and again. Additionally, they can be used to decorate other soft objects including Styrofoam objects, vegetables, and so forth. Moreover, embodiments of the disclosure are safer for children than are the knives, saws, and sharp instruments found in prior art decorating kits. Embodiments of the disclosure offer a creative alternative for decorating a pumpkin, foam object, watermelon, or other object to create a display. Embodiments of the disclosure allow users the opportunity to experience a “hands-on” approach to decorating a pumpkin, watermelon, or other object that all but eliminates the risk of being cut by bladed instruments.

With prior art pumpkin carving kits, a user must use a knife or bladed instrument to cut an image in a pumpkin. When a light source is placed within the pumpkin, the holes cut in the pumpkin are illuminated. Embodiments of the disclosure provide completely different, unique, and novel devices and methods for decorating a pumpkin. In one embodiment, pre-manufactured three-dimensional characters have tapering insertion shafts and, optionally, mechanical stops that limit insertion of the insertion shafts, allow the characters to be attached to a pumpkin by pressing one of the posts into the pumpkin. The result is a safer, less messy, and quicker system that results in a beautiful display, even for those without artistic skills. Moreover, embodiments of the disclosure are reusable and offer a user the ability to create customized displays. Additionally, embodiments of the disclosure allow users to have a hand-on experience and interaction when decorating a pumpkin.

Embodiments of the disclosure advantageously save time when creating a pumpkin display. This is true because prior art carving kits require time to carve designs into the side of the pumpkin. By contrast, embodiments of the disclosure require only a single cut. The press ornaments are then individually placed into the cut portions of the pumpkin. When one half of the pumpkin is pressed into one set of posts extending from the characters, and another half of the pumpkin is pressed into the other set of posts extending from the other end of the characters, a pumpkin display is created. Intricate carving is not required. Simply spacing the press ornaments apart along the single pumpkin cut create contrast when a light source, such as a candle, is placed within the design. The result is a creative, quick, unique, simple, and safe lighted display.

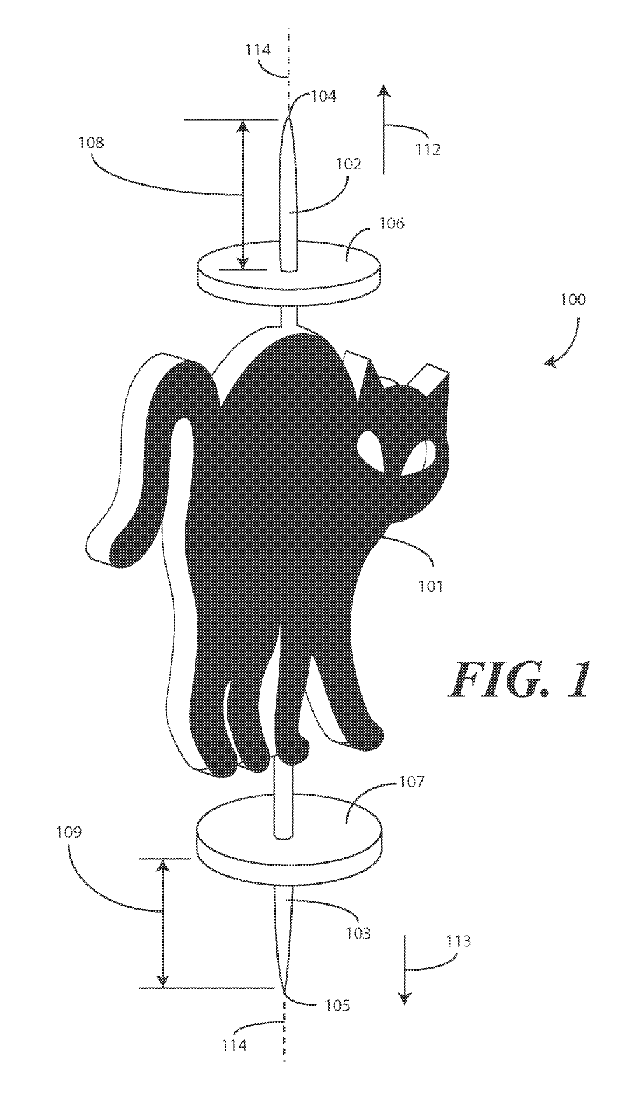

Turning now to FIG. 1, illustrated therein is an explanatory press ornament 100 configured in accordance with one or more embodiments. As shown in FIG. 1, the press ornament 100 includes an ornamental article 101, a first insertion shaft 102 and a second insertion shaft 103. In the illustrative embodiment of FIG. 1, the first insertion shaft 101 extends distally from the ornamental article 101 in a first direction 112. The second insertion shaft 103 extends distally from the ornamental article 101 in a second direction 113.

In this illustrative embodiment, the first insertion shaft 102 and the second insertion shaft 103 extend in opposite directions and are oriented to define an insertion axis 114. While this is one way to orient the first insertion shaft 102 and the second insertion shaft 103, other orientations will be obvious to those of ordinary skill in the art having the benefit of this disclosure. For example, the first insertion shaft 102 and the second insertion shaft 103 could be oriented at orthogonal angles, or at angles selected for a particular application, such as at a thirty-degree angle, sixty-degree angle, and so forth. Additionally, while two insertion shafts are shown in the explanatory embodiment of FIG. 1, it should be noted that three, four, or more insertion shafts could extend distally from the ornamental article 101 as well in other embodiments. Two orthogonal insertion shafts are shown for ease of illustration. However, this depiction is not intended to limit embodiments described below to two insertion shafts unless otherwise noted.

In one embodiment, the first insertion shaft 102 and the second insertion shaft 103 are configured to insert into one or more objects. The one or more objects could be the same object in one embodiment, different objects in another embodiment, or parts or lobes of a single item in another embodiment. The insertion shafts are suitable for insertion into penetrable materials such as the flesh of pumpkins or gourds. However, any number of other objects, either organic or synthetic, can be used with the press ornament 100 of FIG. 1 as well. For example, the first insertion shaft 102 may be inserted into a foam ball or other object, while the second insertion shaft 103 is inserted into a vegetable. Alternatively, the first insertion shaft could be inserted into a cotton ball or other spun or woven object, while the second insertion shaft 103 is inserted into a cake or cookie. The second insertion shaft 103 could be inserted into a foam display stand, while the first insertion shaft 102 is inserted into olives, cherry tomatoes, broccoli, cauliflower, or other snack foods. These varied examples illustrate just a small portion of objects into which the first insertion shaft 102 and the second insertion shaft 103 could be inserted. Others will be obvious to those of ordinary skill in the art having the benefit of this disclosure.

In this illustrative embodiment, the first insertion shaft 102 and the second insertion shaft 103 each taper to a first point 104 and a second point 105, respectively. This tapering to a point helps to facilitate insertion. In one embodiment, the first insertion shaft 102 and the second insertion shaft 103 are to insert into one or more objects to attach the press ornament 100 into one or more objects. The slight sharpening of each insertion shaft provided by the tapering can make the insertion easier in one or more embodiments.

In one or more embodiments, the press ornament 100 optionally comprises one or more mechanical stops 106,107. In this illustrative embodiment, a first mechanical stop 106 is coupled to the first insertion shaft 102, and a second mechanical stop 107 is coupled to the second insertion shaft 103. While the mechanical stops 106,107 can be configured in a variety of ways, the function of the mechanical stops 106,107—where included—can be to limit the distance 108,109 that the first insertion shaft 102 and the second insertion shaft 103 can insert into an object.

In this illustrative embodiment the first mechanical stop 106, and the second mechanical stop 107 are configured a planar elements that are oriented substantially orthogonally with the first insertion shaft 102 and the second insertion shaft 103, respectively. The illustrative planar elements of FIG. 1 are discs that extend orthogonally from the first insertion shaft 102 and the second insertion shaft 103 due to the fact that the discs have a diameter greater than the first insertion shaft 102 and second insertion shaft 103. While discs are one form of planar element, others can be used instead. For example, the planar elements can be configured as other shapes, such as squares or octagons. Additionally, the planar elements can be configured as decorative elements, such as stars, pumpkins, and so forth. In one embodiment, the planar elements are configured to complement the ornamental article 101. Illustrating by example, the ornamental article 101 of FIG. 1 is configured as a cat to serve as a Halloween decoration. Accordingly, the planar element could be configured as a cat as well, or alternatively as a mouse or as a Jack O'Lantern to provide a decorative effect. Just as the mechanical stops 106,107 can be configured as different shapes, they need not be planar in some embodiments. They may rather be configured as hooks, ramps, or other ways. Further, in some embodiments they need not be oriented substantially orthogonally with the first insertion shaft 102 or second insertion shaft 103. Other configurations of the first mechanical stop 106 and the second mechanical stop 107 will be obvious to those of ordinary skill in the art having the benefit of this disclosure.

In the explanatory embodiment of FIG. 1, the ornamental article 101 is configured as a character. The character of this example is that of a cat. As will be shown below, the ornamental article 101 can be configured in any number of ways. In one embodiment, the ornamental article 101 is configured as a different character, such as a pumpkin, a ghost, a bat, a witch, or other character. In another embodiment, the ornamental article 101 is configured as a geometric shape. As briefly alluded to above, the geometric shape can include flat sides suitable for attachment of designs, pictures, logos, advertisements, and the like. Other configurations of the ornamental article 101 will be obvious to those of ordinary skill in the art having the benefit of this disclosure.

The press ornament 100 can be manufactured in a variety of ways. In one embodiment, the press ornament 100 is manufactured as a single, unitary component, with the ornamental article 101, the first insertion post 102, the second insertion post 103, and where included the first mechanical stop 106 and the second mechanical stop 107 manufactured as a single, unitary part. In other embodiments, parts can be assembled together to form the press ornament 100. For example, in one embodiment the ornamental article 101, the first insertion post 102, the second insertion post 103, and the mechanical stops 106,107 can be manufactured as separate components that are adhesively or otherwise coupled together to form the press ornament.

It should be noted that the press ornament 100 can be handmade or made with an industrial manufacturing process. For example, in one embodiment the press ornament 100 is hand-made from one of a variety of materials, including plastic, metal, or wood. In another embodiment, the press ornament 100 is machine made from a material such as plastic, metal or wood. Other materials can be used as well, including but not limited to foam, rubber, cardboard, wood composites, carbon fiber, or combinations thereof.

When made by machine, in one embodiment the press ornament 100 is manufactured from an injection-molding process where moldable plastic is injected into a mold. The moldable plastic may be a thermoset type, a thermosoftening type (also referred to as a thermoplastic), or an elastomer type. The press ornament 100 could also be manufactured from plastic powders where the various components, i.e., the ornamental article 101, first insertion shaft 102, second insertion shaft 103, and so forth, are manufactured by compression, transfer, injection, vacuum, or extrusion molding. Examples of materials suitable for use in these processes include polypropylene, polystyrene, polyester, polyurethane, polyethylene, or combinations thereof. IN one embodiment, the material used to make the press ornament is one of styrene or ABS plastic. In other embodiments, the insertion posts and/or mechanical stops can be configured as a unitary part, with the ornamental article 101 being attached thereto. In some embodiments, the first insertion post 102 and second insertion post 103 can be manufactured from different materials. For example the insertion posts could be ABS plastic while the ornamental article 101 is manufactured from a foam material. Examples of foams suitable for use include polyethylene mini cell foam, ethylene foam, and bead foam. In some embodiments, the ornamental article 101 is then printed or dyed with a color, design, logo, picture, or advertisement.

In one embodiment, the press ornament 100 is manufactured from a colored plastic. In one embodiment, the press ornament 100 is manufactured form a clear plastic. In one embodiment, the press ornament 100 is opaque. In another embodiment, the press ornament 100 is clear. In another embodiment the press ornament 100 is translucent. In another embodiment, parts of the press ornament 100 can be manufactured from different materials. For example, in one embodiment colored glass can be included in the ornamental article for an added visual impact.

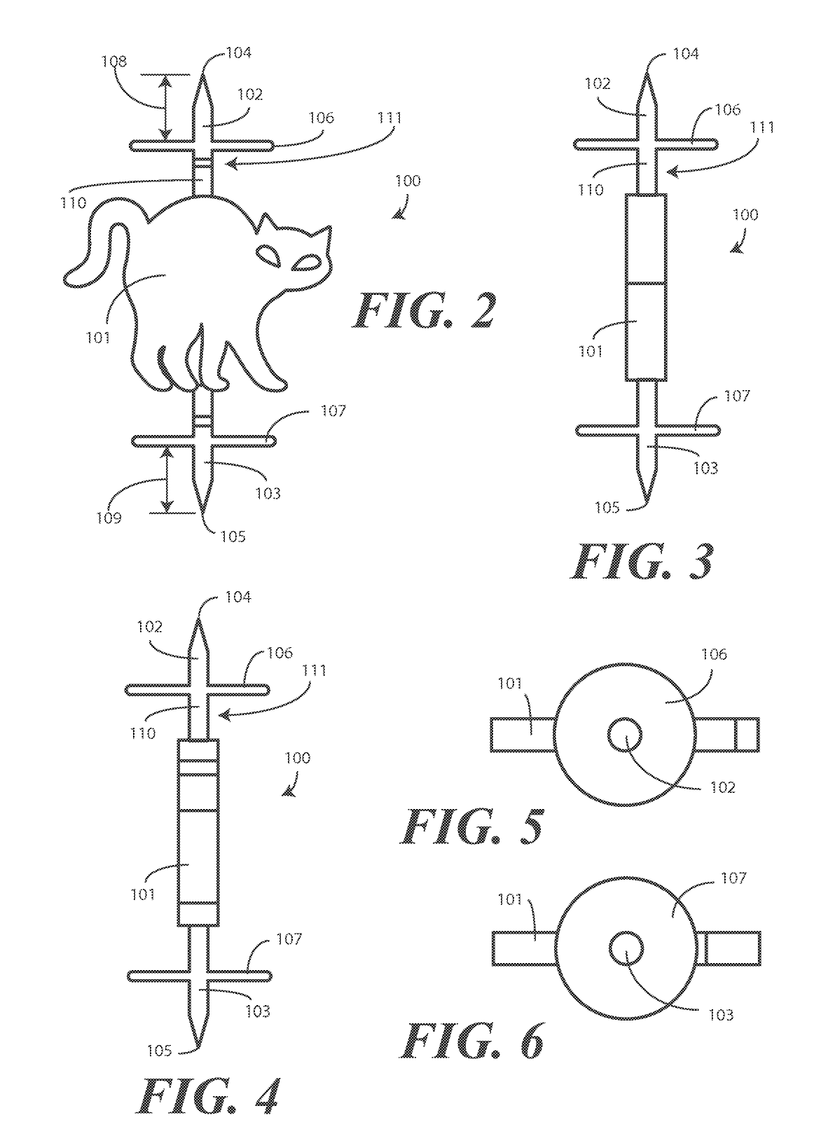

Turning now to FIGS. 2-6, illustrated therein are alternate views of a press ornament 100 configured in accordance with one or more embodiments of the disclosure. FIG. 2 illustrates a front elevation view of the press ornament 100, while FIGS. 3 and 4 illustrate a right elevation view and left elevation view, respectively, of the press ornament 100. FIGS. 5 and 6 illustrate a top plan view and bottom plan view, respectively of the press ornament 100.

This explanatory press ornament 100 includes an ornamental article 101 configured as a character. In this illustrative embodiment, the character is a cat. A first insertion shaft 102 and a second insertion shaft 103, shown as posts in this example, extend from a first end, i.e., the top, of the ornamental article 101 and a second end, i.e., the bottom, of the ornamental article 101, respectively. In one embodiment, the first insertion shaft 102 and the second insertion shaft 103 extend a distance 108,109 sufficient to retain the press ornament 100 securely fastened to one or more objects. As noted above, examples of suitable objects include organic objects, such as vegetables and gourds, synthetic objects, such as woven objects or Styrofoam objects, or combinations thereof. Examples include one of a pumpkin, a watermelon, a turnip, a beet, a potato, or combinations thereof. In one embodiment, the first insertion shaft 102 is to insert into a first lobe of a vegetable or gourd, while the second insertion shaft 103 is to insert into a second lobe of the vegetable or gourd. A user can cut the vegetable or gourd to obtain the two lobes in one or more embodiments.

In one embodiment, the first insertion shaft 102 and the second insertion shaft 103 taper to respective tips or points 104,105. The tips or points 104,105 assist in allowing the first insertion shaft 102 and the second insertion shaft 103 to insert into an object such as pumpkin flesh. In this embodiment, two optional mechanical stops 106,107 are coupled to the first insertion shaft 102 and the second insertion shaft 103. The mechanical stops 106,107 are disposed between the tips 104,105 and the ornamental article 101. Where included, the mechanical stops 106,107 limit the distances 108,109 the first insertion shaft 102 and the second insertion shaft 103 can be pressed and/or inserted into the object. In one embodiment, a space 111 is included between the mechanical stops 106,107 and the ornamental article 101. Including this space is optional.

In one embodiment, an optional axle 110 disposed between the first insertion shaft 102 and the second insertion shaft 103 that allows the ornamental article 101 to spin freely between the first insertion shaft 102 and the second insertion shaft 103. Accordingly, when the first insertion shaft 102 and the second insertion shaft 103 are inserted into an object, such as pumpkin flesh, the ornamental article 101 is free to spin.

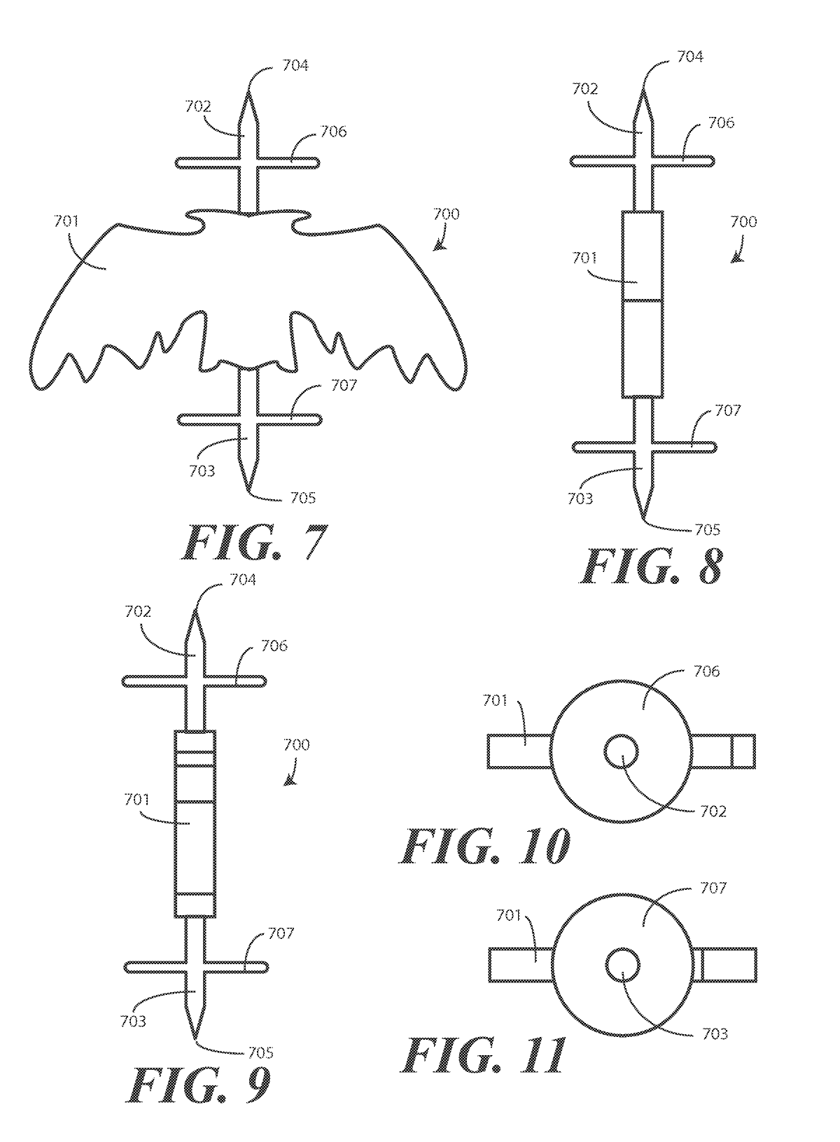

A cat is only one example of a character that the ornamental article 101 can be configured. The ornamental article 101 can be configured as other characters as well. For example, turning to FIGS. 4-11, illustrated therein is another explanatory press ornament 700. The press ornament 400 of FIGS. 4-11 has an ornamental article 701 that is also configured as a character. In this embodiment, the character is a ghost in keeping with the Halloween example provided in FIGS. 2-6. FIG. 4 illustrates a front elevation view of the press ornament 700, while FIGS. 3 and 4 illustrate a right elevation view and left elevation view, respectively, of the press ornament 700. FIGS. 5 and 6 illustrate a top plan view and bottom plan view, respectively of the press ornament 700.

It should be once again noted that the press ornaments 100,700 configured in accordance with one or more embodiments of the disclosure can be configured as any number of characters for any number of holidays, seasons, or events. Illustrating by example, in another embodiment the character portion 701 can be configured and/or themed as a celebratory item for the Fourth of July. Since pumpkins are not traditionally served on the Fourth of July, it is contemplated that the press ornaments can be inserted into objects other than pumpkins without departing from the spirit and scope of this disclosure. Continuing with the Fourth of July example, it is contemplated that press ornaments having character portions corresponding to the Fourth of July could be inserted into watermelons or other plants or vegetables.

As with the press ornament 700 of FIGS. 1-6, the press ornament 700 of FIGS. 4-11 includes two insertion shafts 702,703. In this embodiment, the insertion shafts 702,703 extend from a top and bottom of the character portion 701, respectively. The insertion shafts 302,303 taper to points 704,705, which are suitable for allowing the insertion shafts 702,703 to be easily pressed into pumpkin flesh or other similar materials. In this embodiment, two mechanical stops 706,707 are provided. Where included, the mechanical stops 706,707 serve to limit how far the insertion shafts 702,703 can be pressed into the pumpkin flesh or other material. In one embodiment, the press ornament 700 is manufactured as a single component, with the ornamental article 701, the insertion shafts 702,703, and the mechanical stops 706,707 manufactured as a single, unitary part.

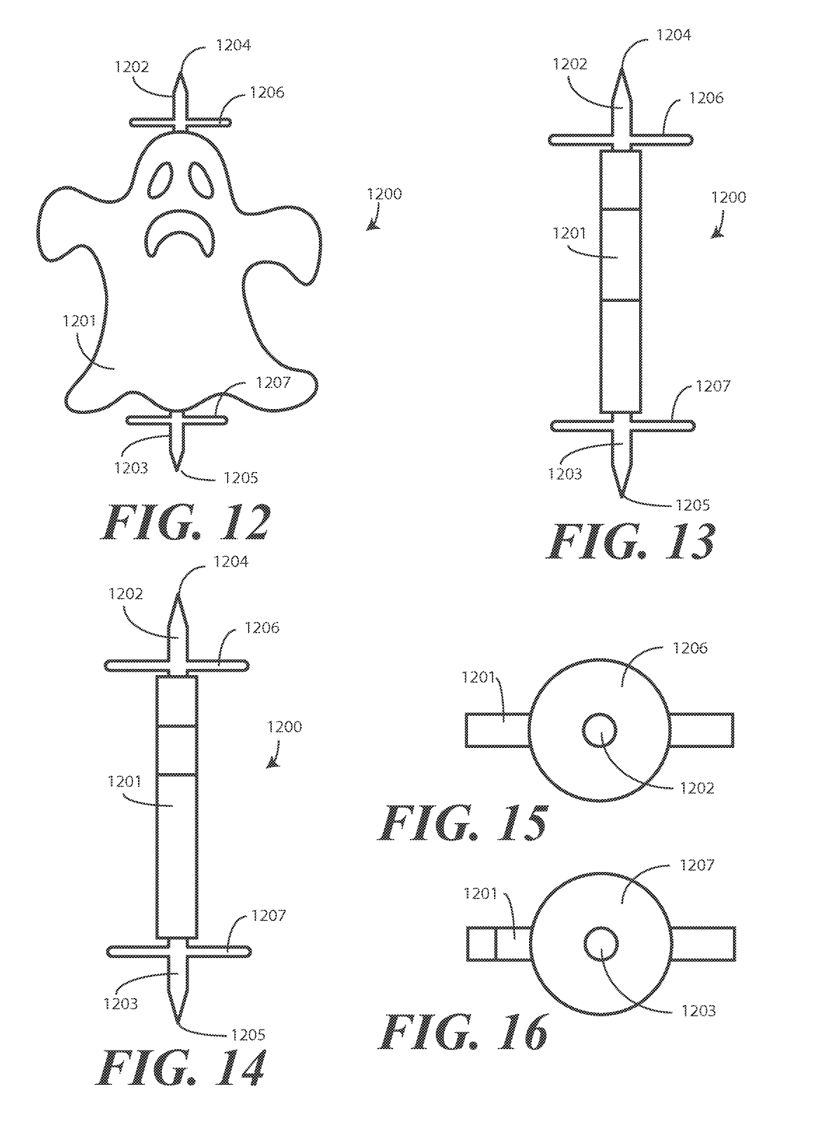

Turning to FIGS. 12-16, illustrated therein is yet another explanatory press ornament 1200. FIG. 12 illustrates a front elevation view of the press ornament 1200, while FIGS. 13 and 14 illustrate a right elevation view and left elevation view, respectively, of the press ornament 1200. FIGS. 15 and 16 illustrate a top plan view and bottom plan view, respectively of the press ornament 1200.

The press ornament 1200 of FIGS. 12-16 has an ornamental article 1201 configured as a character. In this embodiment, the character is a bat to provide yet another example suitable for use in decorating pumpkins for Halloween. As with the previously described press ornaments 100,700, the press ornament 1200 of FIGS. 12-16 includes two extensions, which are shown as insertion shafts 1202,1203. In this embodiment, the insertion shafts 1202,1203 extend from a top and bottom of the ornamental article 1201, respectively. The two insertion shafts 1202,1203 taper to points 1204,1205, which are suitable for allowing the insertion posts 1202,1203 to be easily pressed into a penetrable material. In this embodiment, two mechanical stops 1206,1207 are provided. Where included, the mechanical stops 1206,1207 serve to limit how far the insertion shafts 1202,1203 can be pressed into the penetrable material.

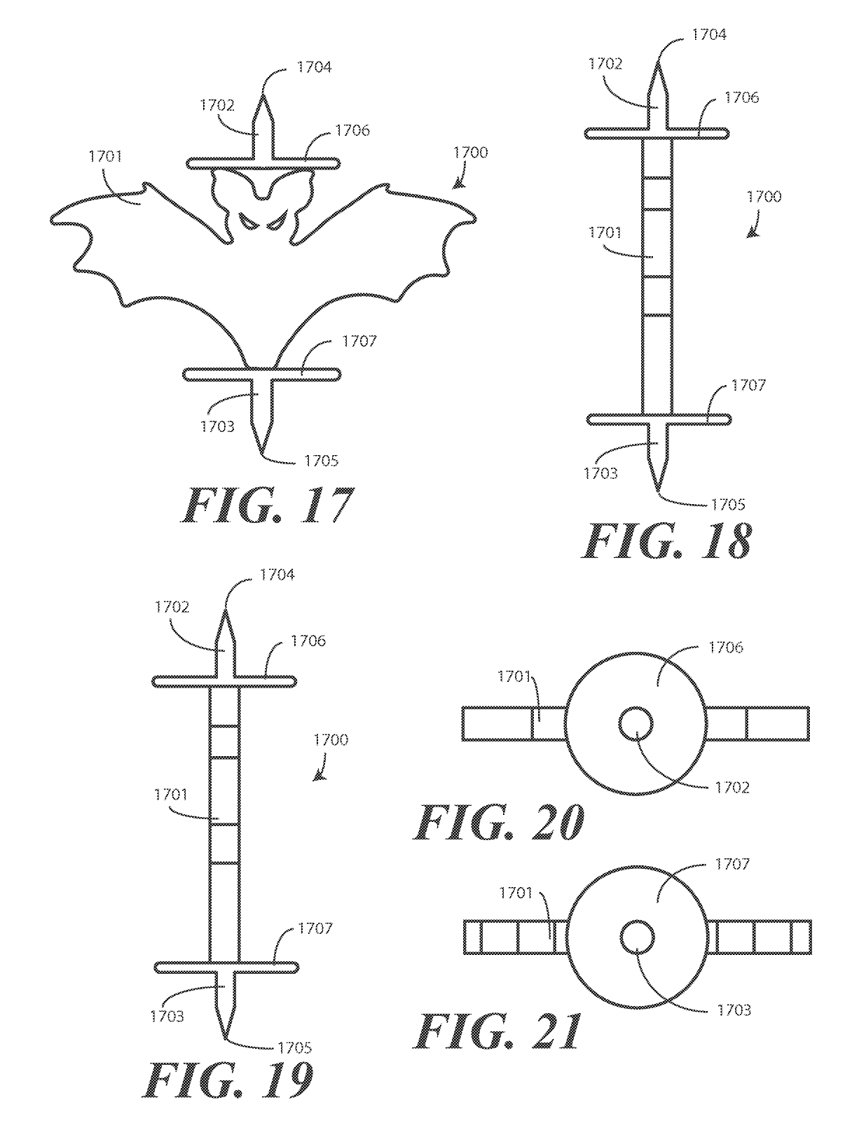

Turning now to FIGS. 17-21, illustrated therein is yet another press ornament 1700 configured in accordance with one or more embodiments of the disclosure. FIG. 17 illustrates a front elevation view of the press ornament 1700, while FIGS. 18 and 19 illustrate a right elevation view and left elevation view, respectively, of the press ornament 1700. FIGS. 20 and 21 illustrate a top plan view and bottom plan view, respectively of the press ornament 1700.

This explanatory press ornament 1700 includes an ornamental article 1701 configured as a character. In this illustrative embodiment, the character is a different type of bat. A first insertion shaft 1702 and a second insertion shaft 1703 extend from a first end of the ornamental article 1701 and a second end of the ornamental article 1701, respectively. In one embodiment, the first insertion shaft 1702 and the second insertion shaft 1703 extend a distance sufficient to retain the press ornament 1700 securely fastened to one or more objects.

In one embodiment, the first insertion shaft 1702 and the second insertion shaft 1703 taper to respective tips or points 1704,1705. The tips or points 1704,1705 assist in allowing the first insertion shaft 1702 and the second insertion shaft 1703 to insert into an object such as pumpkin flesh.

In this embodiment, two optional mechanical stops 1706,1707 are coupled to the first insertion shaft 1702 and the second insertion shaft 1703. In this embodiment, the first insertion shaft 1702 extends from, and terminates at, one of the mechanical stops 1706. Where included, the mechanical stops 1706,1707 limit the distance the first insertion shaft 1702 and the second insertion shaft 1703 can be pressed and/or inserted into the object.

It should be noted that inclusion of the mechanical stops 1706,1707 is not mandatory. In contrast to the embodiment of FIGS. 2-6, where a space (111) was included between the mechanical stops (106,107) and the ornamental article (101). In the embodiment of FIGS. 17-21, no space is included between mechanical stop 1706 and the ornamental article 1701. Accordingly, the mechanical stop 1706 could be omitted in this embodiment, with the first insertion shaft 1702 extending from the head of the bat. The bat's ears could then function as a mechanical stop in this embodiment. In other embodiments, it may be desirable to have a portion of the ornamental article 1701 insert into the object is well. For example, where the ornamental article is configured a tree, it may be desirable to have a portion of the tree embed in the vegetable, gourd, or other object to which the press ornament 1700 is attached. Accordingly, the mechanical stops may be omitted, or alternatively coupled to the ornamental article 1701 instead of one or both insertion shafts 1702,1703.

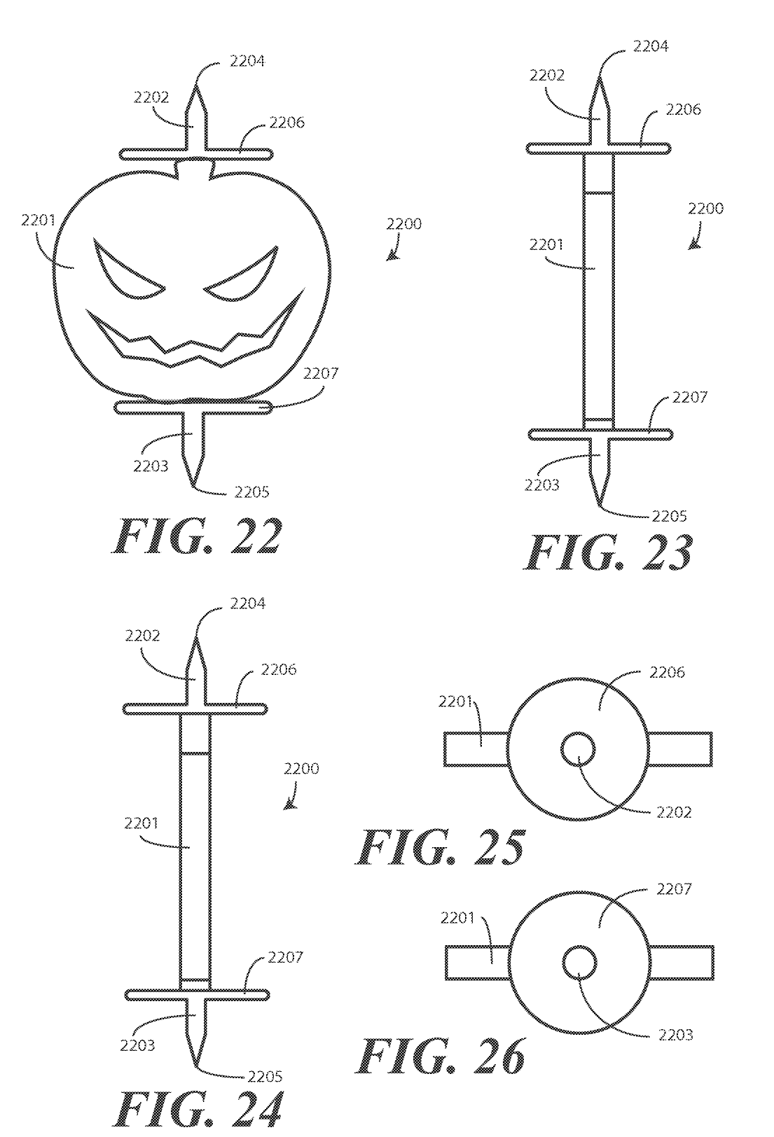

Turning to FIGS. 22-26, illustrated therein is another explanatory press ornament 2200. The press ornament 2200 of FIGS. 22-26 has an ornamental article 2201 that is also configured as a character. In this embodiment, the character is a Jack O'Lantern in keeping with the Halloween examples provided above. FIG. 22 illustrates a front elevation view of the press ornament 2200, while FIGS. 23 and 24 illustrate a right elevation view and left elevation view, respectively, of the press ornament 2200. FIGS. 25 and 26 illustrate a top plan view and bottom plan view, respectively of the press ornament 2200.

The press ornament 2200 of FIGS. 22-26 includes two insertion shafts 2202,2203. In this embodiment, the insertion shafts 2202,2203 extend from a top and bottom of the character portion 2201, respectively. The insertion shafts 2202,2203 taper to points 2204,2205, which are suitable for allowing the insertion shafts 2202,2203 to be easily pressed into pumpkin flesh or other similar materials. In this embodiment, two mechanical stops 2206,2207 are provided. Where included, the mechanical stops 2206,2207 serve to limit how far the insertion shafts 2202,2203 can be pressed into the pumpkin flesh or other material. In one embodiment, the press ornament 2200 is manufactured as a single component, with the ornamental article 2201, the insertion shafts 2202,2203, and the mechanical stops 2206,2207 manufactured as a single, unitary part.

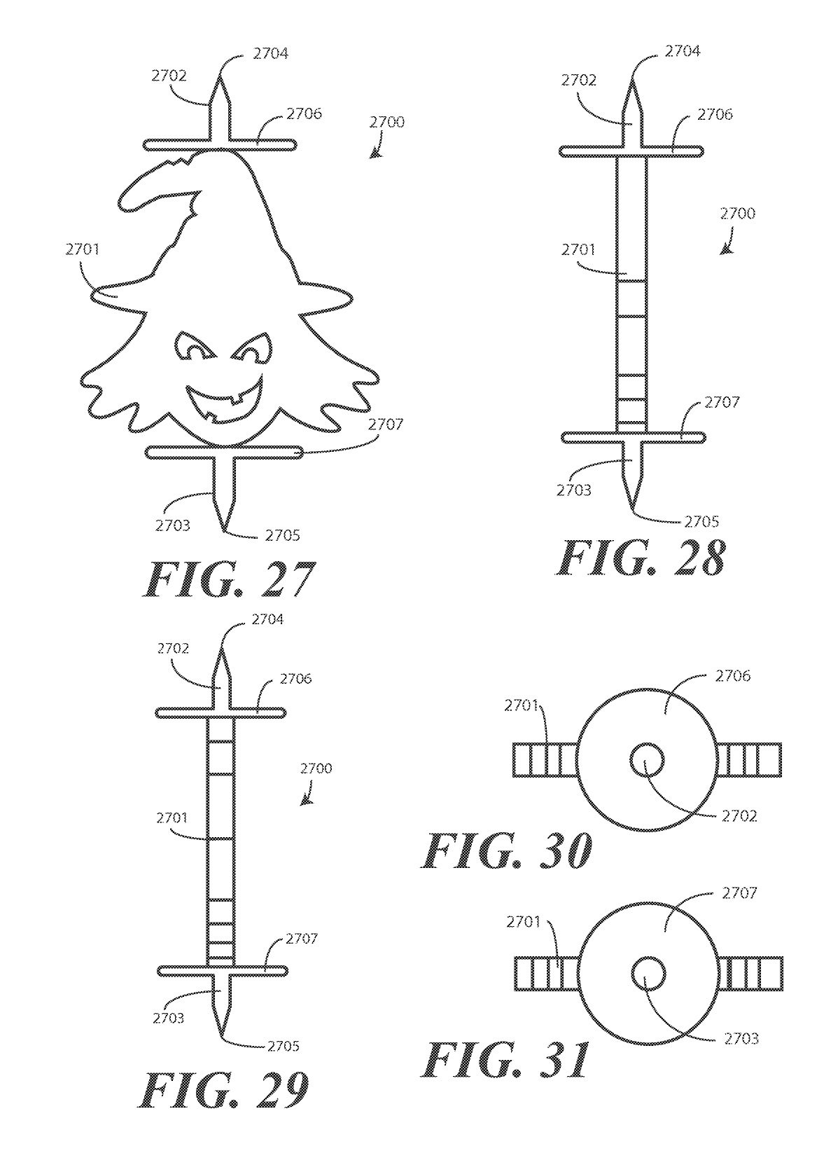

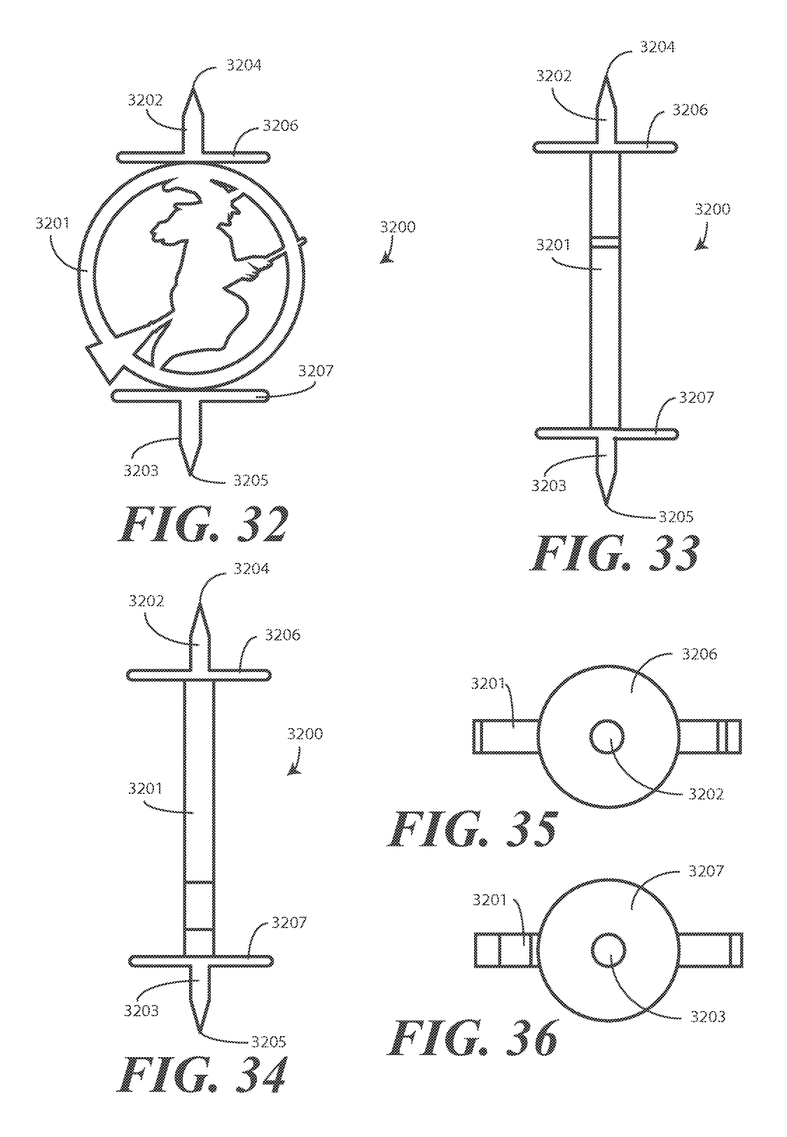

Turning to FIGS. 17-31, illustrated therein is yet another explanatory press ornament 2700. FIG. 27 illustrates a front elevation view of the press ornament 2700, while FIGS. 28 and 29 illustrate a right elevation view and left elevation view, respectively, of the press ornament 2700. FIGS. 30 and 31 illustrate a top plan view and bottom plan view, respectively of the press ornament 2700.

The press ornament 2700 of FIGS. 27-31 has an ornamental article 2701 configured as a character. In this embodiment, the character is a witch to provide yet another example suitable for use in decorating pumpkins for Halloween. The press ornament 2700 of FIGS. 27-31 includes two extensions, which are shown as insertion shafts 2702,2703. In this embodiment, the insertion shafts 2702,2703 extend from a top and bottom of the ornamental article 2701, respectively. The two insertion shafts 2702,2703 taper to points 2704,2705, which are suitable for allowing the insertion posts 2702,2703 to be easily pressed into a penetrable material. In this embodiment, two mechanical stops 2706,2707 are provided. Where included, the mechanical stops 2706,2707 serve to limit how far the insertion shafts 2702,2703 can be pressed into the penetrable material.

Turning to FIGS. 32-36, illustrated therein is yet another explanatory press ornament 3200. FIG. 32 illustrates a front elevation view of the press ornament 3200, while FIGS. 33 and 34 illustrate a right elevation view and left elevation view, respectively, of the press ornament 3200. FIGS. 35 and 36 illustrate a top plan view and bottom plan view, respectively of the press ornament 3200.

The press ornament 3200 of FIGS. 32-36 has an ornamental article 3201 configured as a silhouette. In this embodiment, the silhouette is a witch on a broomstick circumscribed by an orb. The press ornament 3200 of FIGS. 32-36 includes two extensions, which are shown as insertion shafts 3202,3203. In this embodiment, the insertion shafts 3202,3203 extend from a top and bottom of the ornamental article 3201, respectively. The two insertion shafts 3202,3203 taper to points 3204,3205, which are suitable for allowing the insertion posts 3202,3203 to be easily pressed into a penetrable material. In this embodiment, two mechanical stops 3206,3207 are provided. Where included, the mechanical stops 23206,3207 limit how far the insertion shafts 3202,3203 can be pressed into the penetrable material.

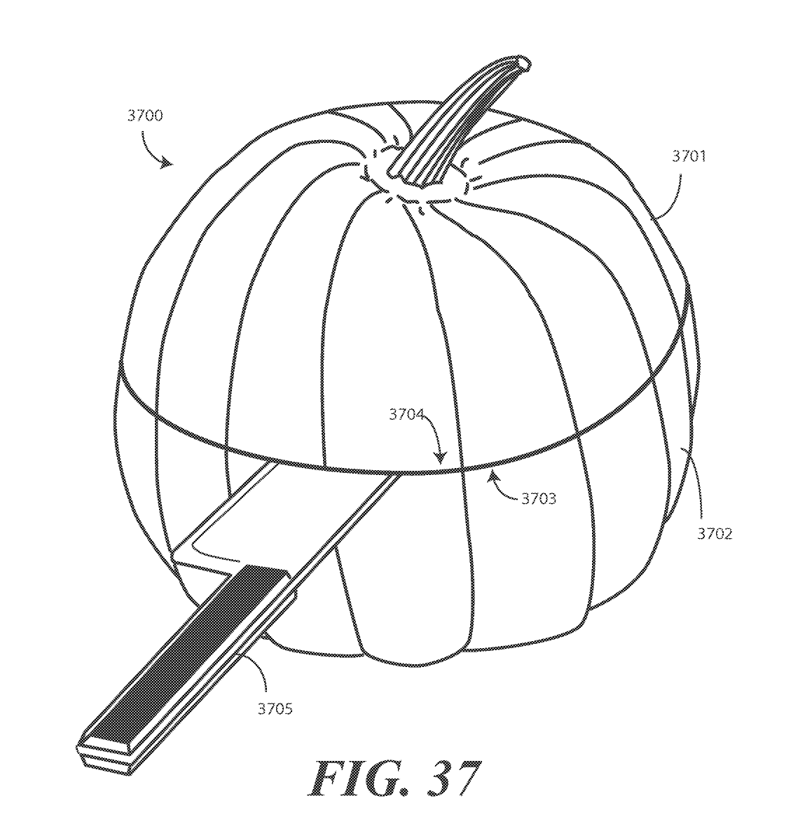

Turning now to FIGS. 37-41, illustrated therein is a method of creating a pumpkin display. The method generally includes inserting a first insertion shaft of a press ornament into a first object and inserting a second insertion shaft of the press ornament into a second object to display an ornamental article between the first object and the second object. The first object and the same object can be parts of a single entity, e.g., a partially split pumpkin in one embodiment. In other embodiments, the first object can be different from the second object. In one embodiment, the ornamental article is holiday themed.

In one embodiment, the first object and the second object comprise a first lobe of one or more vegetables or gourds and a second lobe of one or more vegetables or gourds. For example, the first object can comprise a first lobe of an item, while the second object comprises a second lobe of the item. Where this is the case, the method can further comprise cutting the item to obtain the first lobe and the second lobe.

In one or more embodiments, the method also includes placing a light source within the object. The ornamental articles can selectively block light being emitted from the light source to provide a backlit glow for each ornamental article. In one or more embodiments, as will be described in more detail below with reference to FIGS. 43, 44, and 46, the method can also comprise decorating the ornamental article. For example, in one embodiment the decorating comprises one or more of applying a coloring agent, e.g., dye, paint, or ink, to, applying a sticker to, or writing on the ornamental article.

Using the creation of a pumpkin display for illustration purposes, and beginning with FIG. 37, a user cuts a pumpkin 3700 (or watermelon or other object that will be transformed into a display) into two lobes 3701,3702. The user may employ a knife 3705 or other implement to perform this cutting action. Where a knife 3705 is used, this is the only cutting step that is required to create a pumpkin display in accordance with embodiments of the disclosure. Once this is complete, the user separates the two lobes 3701,3702 and optionally removes the inner meat of the pumpkin 500 so that a light source can be placed therein.

It should be noted that it is not necessary to employ a knife 3705 to obtain the two lobes, 3701,3702, however. As noted above, one advantage of embodiments of the disclosure is that cutting is not needed, thereby making the use of press ornaments configured in accordance with embodiments of the disclosure safer for children. Accordingly, for those not interested in using the knife 3705 for cutting, the pumpkin 3700 may alternatively be broken by mechanical means. For example, a user may drop the pumpkin 3700 on a hard surface to break the pumpkin 3700 into two, three, four, or more pieces (each of these pieces is also referred to herein as a lobe). The lobes can then be “stitched” back together using press ornaments as described above for a wicked awesome super sick ornamental appearance of the resulting display.

From this point, the only components required to complete the pumpkin display are the press ornaments themselves. They interact only as far as how they are arranged on the pumpkin 3700. The user has the freedom to customize how close or far they are placed from each other along the edges 3703,3704 of the lobes 3701,3702. As will be described below, this relationship, i.e., how far apart or close together each press ornament is, will affect how much light emanates from the light source disposed within the pumpkin 3700.

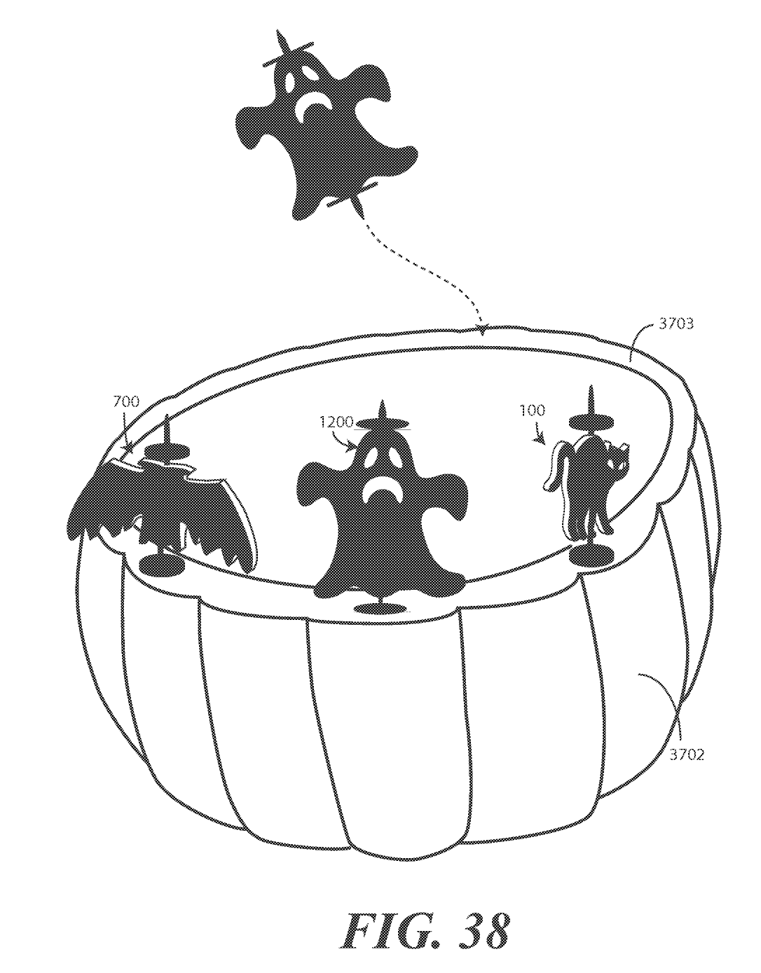

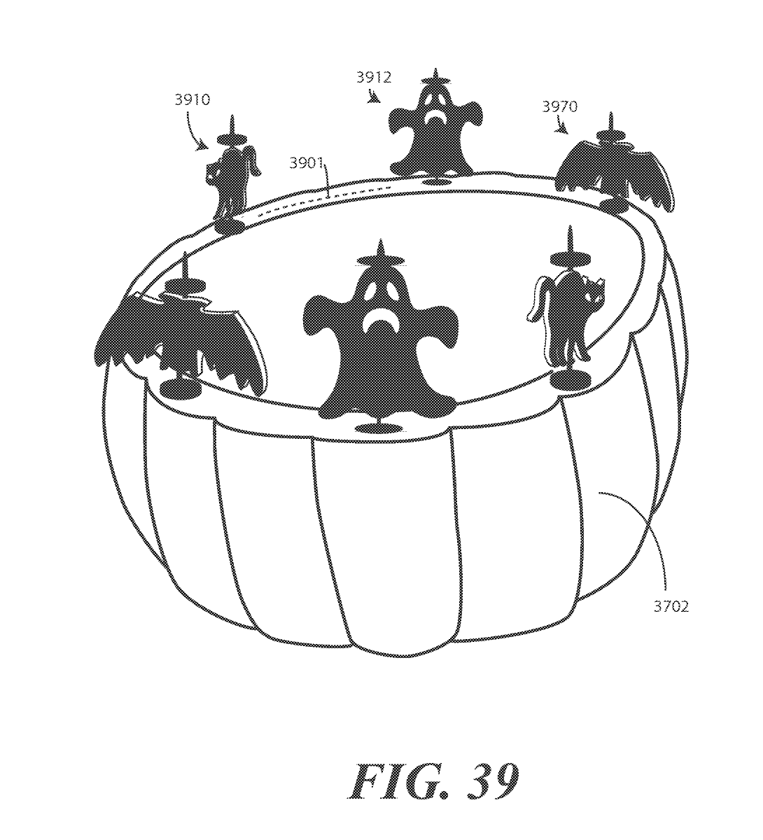

Turning to FIG. 38, the user the lightly presses a plurality of press ornaments 100, 700, 1200 into an edge 3703 of a lobe 3702. In one embodiment, the press ornaments 100, 700, 1200 are pressed into the edge 3703 of the lobe 3702 until their insertion shafts 103, 703, 1203 go far enough into the edge 3703 of the lobe 3702 until the ornamental article 101, 701, 1201 or the mechanical stop 107, 707, 1207 sits flush with the edge 3703 of the lobe 3702. As noted above, in some embodiments a user may desire to insert a portion of the ornamental article 101, 701, 1201 into the edge 3703 of the lobe 3702 as well. As shown in FIG. 39, additional press ornaments 3910, 3970, 3912 are installed about the circumference 3901 of the lobe 3702. As noted above, the user has the freedom to choose how far apart or close together to space the press ornaments 3910, 3970, 3912.

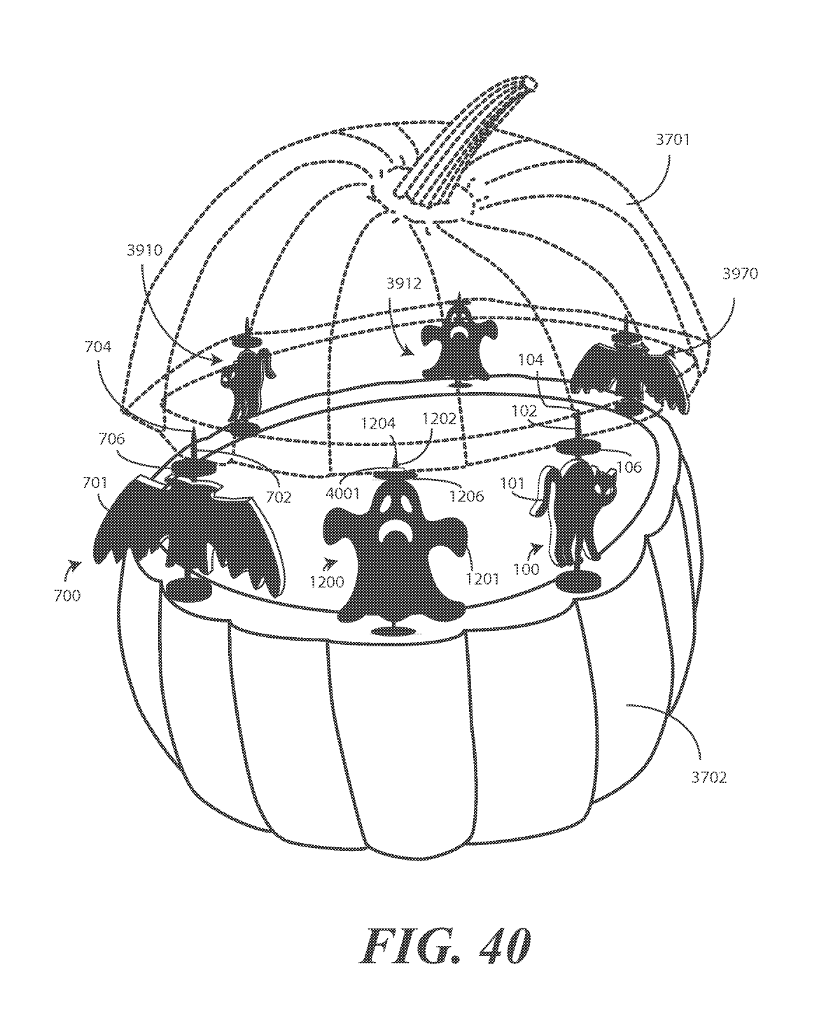

Turning to FIG. 40, the other lobe 3701 is then pressed lightly toward the first lobe 3702. This causes the points 104, 704, 1204 to penetrate the edge 3704 of the other lobe 3701. The insertion shafts 102, 702, 1202 then press into the flesh of the other lobe 3701. In one embodiment, the user may press the other lobe 3701 toward the first lobe 3702 into until the insertion shafts 102, 702, 1202 go far enough into the edge 3704 of the other lobe 3701 that either the ornamental article 101, 701, 1201 or the mechanical stop 106, 706, 1206 sits flush with the edge 3705 of the other lobe 3701. As noted above, in some embodiments a user may desire to insert a portion of the ornamental article 101, 701, 1201 into the edge 3705 of the other lobe 3701 as well. The same action occurs with press ornaments 3910, 3970, 3912 in one embodiment, as shown in FIG. 40. In one embodiment, a tooling anomaly 4001 can be manufactured into the press ornaments, e.g., press ornament 700, to act as a visual indicator to indicate the lobe 3701 is flush with one of the mechanical stop 106, 706, 1206, the ornamental article 101, 701, 1201, or some portion of the ornamental article 101, 701, 1201.

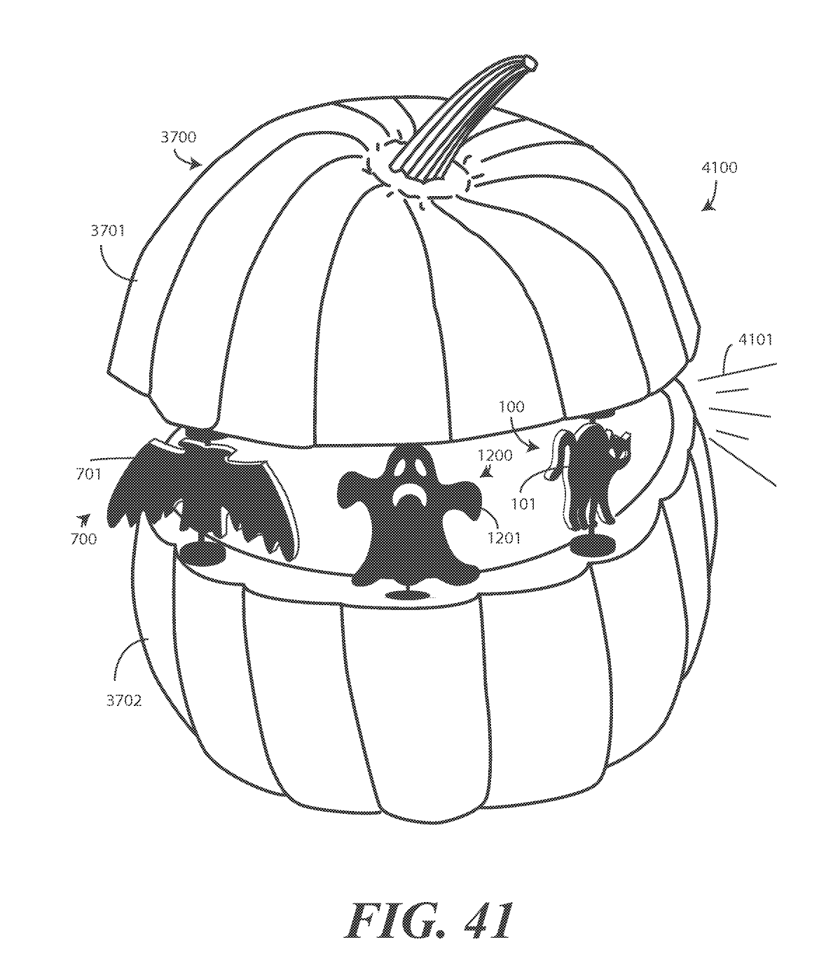

The number of press ornaments used can vary. The six shown in FIGS. 40 and 41 are used for example only. In some embodiments three press ornaments can be used. In other embodiments fifteen press ornaments are used. These are examples only.

Turning now to FIG. 41, illustrated therein is the completed pumpkin display 4100. When a light source is placed within the pumpkin 3700, such as a candle, LED, or incandescent light, the spacing of the press ornaments 100, 700, 1200 affects the amount of light 4101 that emanates from the pumpkin display 4100.

Embodiments of the disclosure contemplate that lighted pumpkin displays depend upon contrast to create the displayed effect. In the pumpkin display 4100 of FIG. 41, the press ornaments 100, 700, 1200 selectively block the light 4101. This results in a silhouetting effect provided by the character portions 101, 701, 1201. This silhouetting effect mimics the effect produced by a traditional carved pumpkin with a candle placed inside. When the press ornaments 100, 700, 1200 are securely fastened to the pumpkin 3700 by way of their first insertion shaft 102 and the second insertion shaft 103, 702, 703, 1202, 1203 the character portions 101, 701, 1201 are fixed (unless disposed on an axle (110) as described above). In either case, the character portions 101, 701, 1201 selectively block light from a light source disposed within the pumpkin 3700, thereby making the pumpkin display 4100 appear to glow.

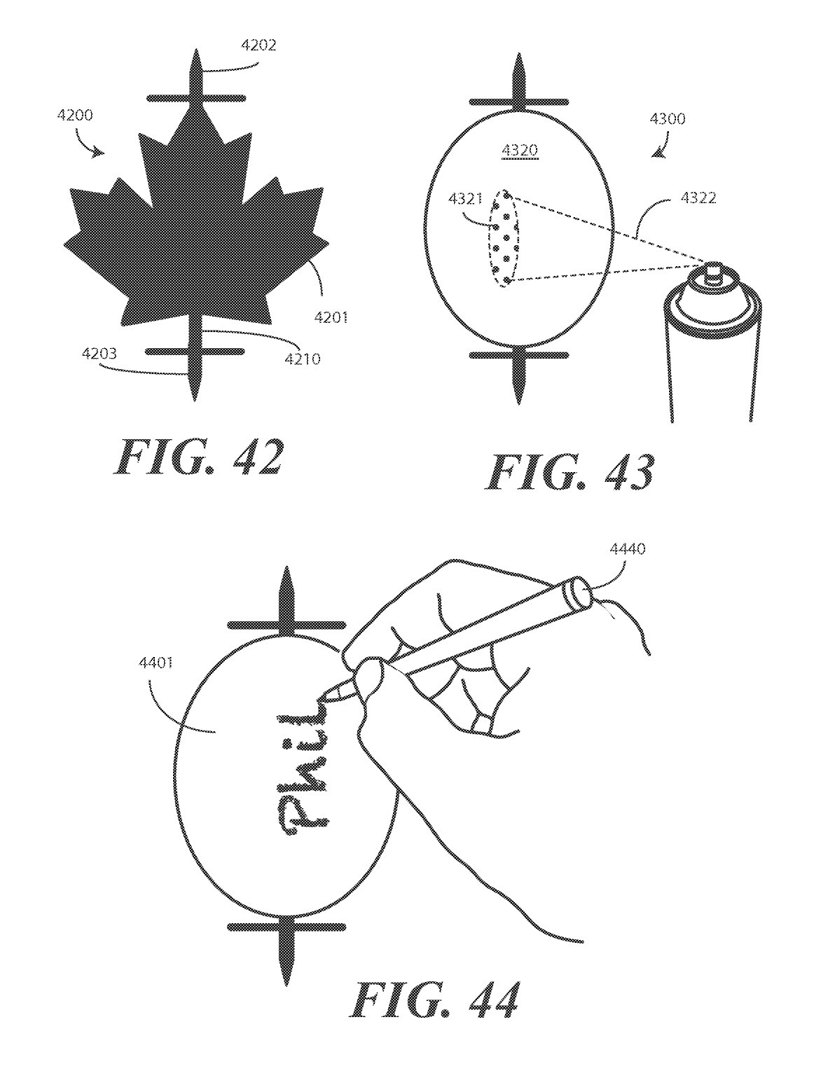

Turning now to FIG. 42, illustrated therein is yet another press ornament 4200 configured in accordance with one or more embodiments of the disclosure. As with previous embodiments, the press ornament 4200 of FIG. 42 includes a decorative article 4201. However, in this embodiment, the decorative article 4201 is not configured as a character. It is instead configured as a natural object, which in this embodiment is a leaf. The leaf is an example of a natural object that allows the decorative article 4201 to be holiday themed, with the holiday being Thanksgiving in this illustrative embodiment.

The press ornament 4200 includes two insertion posts 4202,4203 that extend from a top of the ornamental element 4201 and a bottom of the ornamental element 4201, respectively. In one embodiment, an optional axle 4210 disposed between the insertion shafts 4202,4203 that allows the decorative article 4201 to spin freely between the insertion shafts 4202,4203. Accordingly, when the insertion shafts 4202,4203 are inserted into an object, such as pumpkin flesh, the ornamental article 4201 is free to spin.

Turning now to FIG. 43, illustrated therein is another explanatory press ornament 4300 and method of decorating the same, both in accordance with one or more embodiments of the disclosure. As with previous embodiments, the press ornament 4300 of FIG. 43 includes a decorative article 4301. However, in this embodiment, the decorative article 4301 is not configured as a character or natural object. It is instead configured as a geometric shape having substantially flat sides 4320 upon which decorations 4321 may be placed.

In one embodiment, the decorations 4321 comprise designs, pictures, advertising, logos, or other objects. For example the decorations 4321 can comprise printed advertising, designs, pictures, or other objects. Printed advertising can include, for example, logos, pictures and slogans from professional sports teams, collegiate sports teams, high school sports teams, and recreational sports teams. The decorations 4321 can also comprise advertisements for children's products, toys, and movies. The decorations 4321 can comprise fashion designs and personalized pictures.

In one or more embodiments, the flat sides 4320 can be configured for screen or laser printing, such that the decorations 4321 can be printed thereon. In other embodiments, the flat sides 4320 can be covered with a fabric and/or sticker that contains dyed or printed advertising and/or designs. Where covered with fabric or a sticker, the decorative article 4301 can be customized repeatedly by changing the decorations 4321 frequently and/or often.

In the embodiment of FIG. 43, a user is applying the decoration 4321. In this illustrative embodiment, a user is applying a coloring agent—in the form of paint 4322—to the ornamental article 4201. By contrast, in FIG. 44 a user is writing on the decorative article 4401 with a writing instrument 4440. Similarly, in FIG. 46, a user is applying a sticker 4640 to the decorative article 4601.

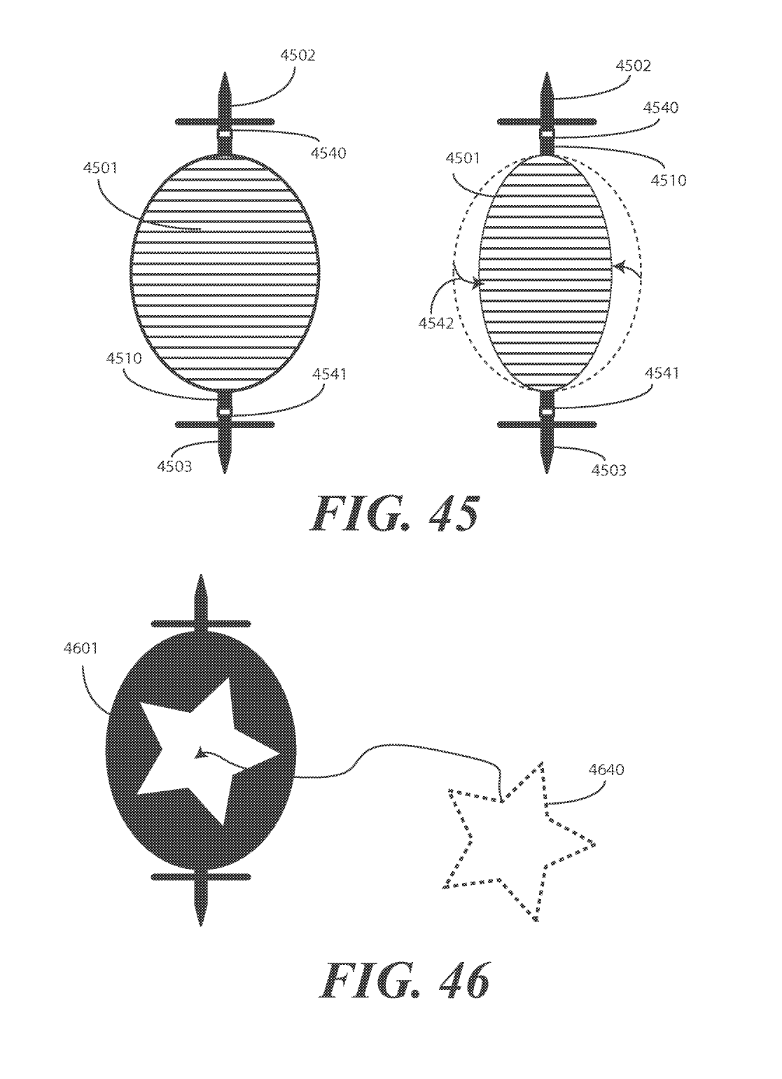

Turning to FIG. 45, illustrated therein is a spindle embodiment where hinges 4540,4541 are disposed between an axle 4510 and the insertion shafts 4502,4503 to allow the ornamental article 4501 to spin 4542. When used in a pumpkin with a candle or light inside, the hinges 4540,4541 allow wind or breezes to spin 4542 the ornamental article 4501. This creates a “flickering effect” that is simply not possible with prior art pumpkin decorating kits and is another example of the uniqueness offered by embodiments of the disclosure.

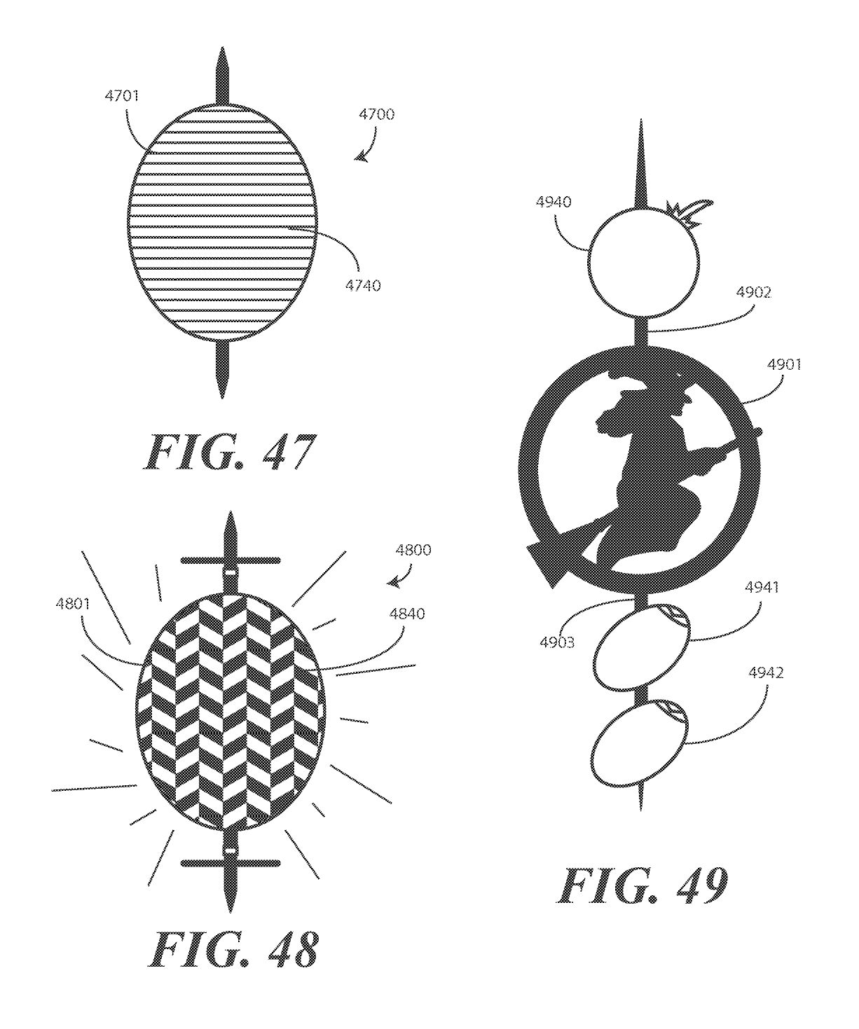

Turning now to FIG. 47, illustrated therein is a press ornament 4700 that includes no mechanical stops. The breadth of the ornamental article 4701 serves as the mechanical stop, so no additional mechanical stop is required. The ornamental article 4701 of FIG. 47 is also manufactured from colored, semi-transparent material 4740. Turning to FIG. 48, the ornamental article 4801 of this press ornament 4800 is manufactured from glow in the dark material 4840.

To this point, embodiments of the disclosure have been described as optimally used in decorating vegetables, gourds, and other objects. However, it will be obvious to those of ordinary skill in the art having the benefit of this disclosure that embodiments of the disclosure are not so limited. Turning now to FIG. 49, illustrated therein is a press ornament 4900 being used as a serving utensil. Rather than inserting the insertion posts 4902,4903 into lobes of a gourd, edibles have been placed on each so that they can be attractively displayed about the decorative article 4901. Illustrating by example, a cherry tomato 4901 and two cocktail olives 4941,4942 are placed on the insertion posts 4902,4903. In this application, the press ornament 4900 serves as a fun and whimsical way to serve hors d'oeuvres and other tasty treats. Other applications for press ornaments will be obvious to those of ordinary skill in the art having the benefit of this disclosure.

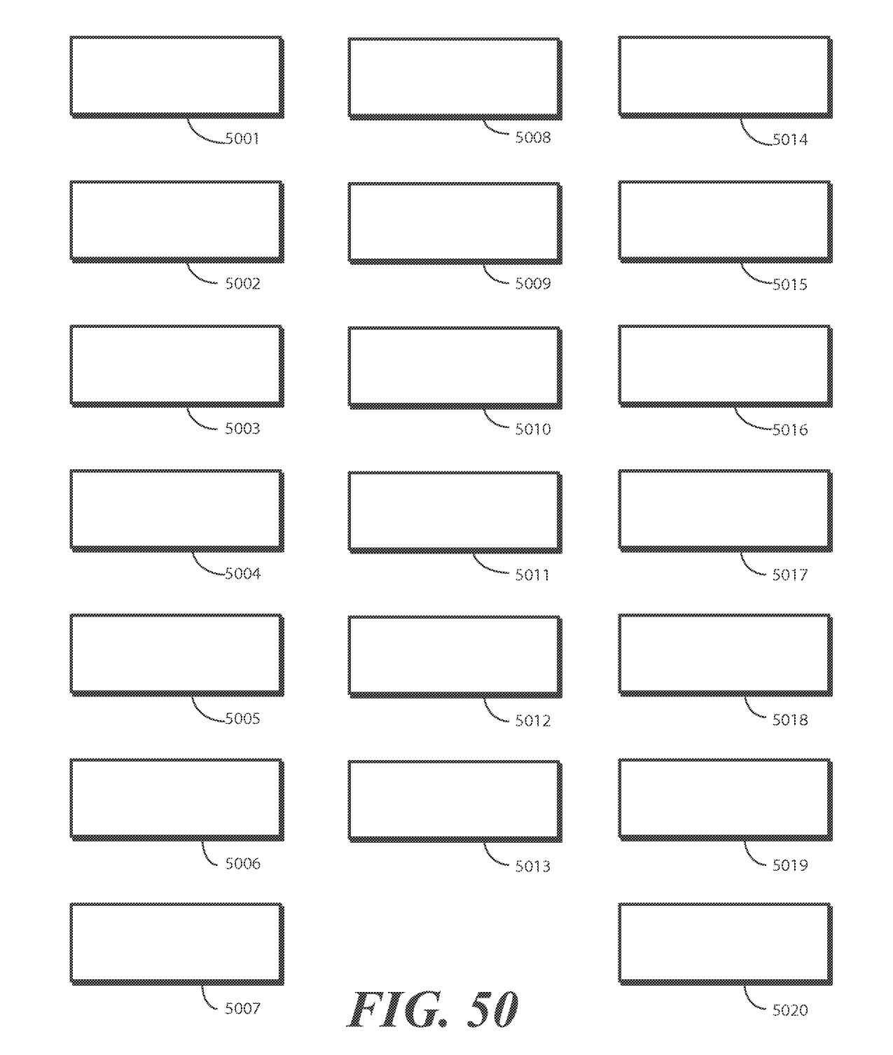

Turning now to FIG. 50, illustrated therein are various embodiments of the disclosure. At 5001, a press ornament comprises an ornamental article, a first insertion shaft extending distally from the ornamental article in a first direction, and a second insertion shaft extending distally from the ornamental article in a second direction. At 5001, the first insertion shaft and the second insertion shaft are to insert into one or more objects to attach the press ornament to the one or more objects.

At 5002, the first insertion shaft and the second insertion shaft of 5001 taper to a first point and a second point, respectively. At 5003, the first insertion shaft and the second insertion shaft of 5001 are oriented to define an insertion axis. At 5003, the first direction of 5001 is opposite the second direction of 5001.

At 5004, the press ornament of 5001 further comprises a mechanical stop coupled to one of the first insertion shaft or the second insertion shaft to limit a distance the one of the first insertion shaft or the second insertion shaft can insert in the one or more objects. At 5005, the mechanical stop of 5004 comprises a planar element. At 5005, the planar element is substantially orthogonal with, and greater in diameter than, one of the first insertion shaft or the second insertion shaft.

At 5006, the one or more objects of 5001 comprise a first lobe and a second lobe of one or more vegetables or gourds. At 5007, the one or more vegetables or gourds of 5006 comprise one of a pumpkin, a watermelon, a turnip, a beet, a potato, or combinations thereof.

At 5008, the ornamental article of 5001 comprises a character. At 5009, the character of 5008 comprises one or more of a pumpkin, a ghost, a cat, a bat, a witch, a geometric shape, or a leaf.

At 5010, the ornamental article of 5001 is clear. At 5011, the ornamental article of 5001 is opaque. At 5012, the ornamental article, the first insertion shaft, and the second shaft of 5001 are manufactured as a unitary part. At 5013, the unitary part of 5012 is injection molded. At 5014, the ornamental article of 5001 is holiday themed.

At 5015, a method of creating a display comprises inserting a first insertion shaft of a press ornament into a first object. At 5015, the method further comprises inserting a second insertion shaft of the press ornament into a second object to display an ornamental article between the first object and the second object. At 5016, the method of 5015 further comprises placing a light source within the object.

At 5017, the first object of 5015 and the second object of 5015 are different. At 5018, the first object of 5015 comprises a first lobe of an item. At 5018, the second object of 5018 comprises a second lobe of the item. At 5018, the method of 5015 further comprises cutting the item to obtain the first lobe and the second lobe.

At 5019, the method of 5015 further comprises decorating the ornamental article. At 5020, the decorating of 5019 comprises one or more of applying a coloring agent to, applying a sticker to, or writing on the ornamental article.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A press ornament, comprising:
an ornamental article;
a first insertion shaft extending distally from the ornamental article in a first direction; and
a second insertion shaft extending distally from the ornamental article in a second direction;
the first insertion shaft and the second insertion shaft to insert into one or more objects to attach the press ornament to the one or more objects.

2. The press ornament of claim 1, the first insertion shaft and the second insertion shaft tapering to a first point and a second point, respectively.

3. The press ornament of claim 1, the first insertion shaft and the second insertion shaft oriented to define an insertion axis, the first direction being opposite the second direction.

4. The press ornament of claim 1, further comprising a mechanical stop coupled to one of the first insertion shaft or the second insertion shaft to limit a distance the one of the first insertion shaft or the second insertion shaft can insert in the one or more objects.

5. The press ornament of claim 4, the mechanical stop comprising a planar element substantially orthogonal with, and greater in diameter than, the one of the first insertion shaft or the second insertion shaft.

6. The press ornament of claim 1, the one or more objects comprising a first lobe and a second lobe of one or more vegetables or gourds.

7. The press ornament of claim 6, the one or more vegetables or gourds comprising one of a pumpkin, a watermelon, a turnip, a beet, a potato, or combinations thereof.

8. The press ornament of claim 1, the ornamental article comprising a character.

9. The press ornament of claim 8, the character one or more of a pumpkin, a ghost, a cat, a bat, or a witch.

10. The press ornament of claim 1, the ornamental article clear.

11. The press ornament of claim 1, the ornamental article opaque.

12. The press ornament of claim 1, the ornamental article, the first insertion shaft, and the second shaft manufactured as a unitary part.

13. The press ornament of claim 12, the unitary part injection molded.

14. The press ornament of claim 1, the ornamental article holiday themed.

15. A method of creating a display, comprising:
inserting a first insertion shaft of a press ornament into a first object; and
inserting a second insertion shaft of the press ornament into a second object to display an ornamental article between the first object and the second object.

16. The method of claim 15, further comprising placing a light source within the object.

17. The method of claim 15, the first object different from the second object.

18. The method of claim 17, the first object comprising a first lobe of an item, the second object comprising a second lobe of the item, the method further comprising cutting the item to obtain the first lobe and the second lobe.

19. The method of claim 15, further comprising decorating the ornamental article.

20. The method of claim 19, the decorating comprising one or more of applying a coloring agent to, applying a sticker to, or writing on the ornamental article.
